(19) United States
(12) Patent Application Publication
(10) Pub. No.: US 2015/0264361 A1
(43) Pub. Date: Sep. 17, 2015

(54) METHOD FOR SCREEN CONTENT CODING

(71) Applicant: Huawei Technologies Co., Ltd., Shenzhen (CN)

(72) Inventors: Thorsten Laude, Hannover (DE); Jorn Ostermann, Hannover (DE); Marco Munderloh, Hannover (DE); Haoping Yu, Carmel, IN (US)

(21) Appl. No.: 14/657,744

(22) Filed: Mar. 13, 2015

Related U.S. Application Data
(60) Provisional application No. 61/952,158, filed on Mar. 13, 2014.
(60) Provisional application No. 62/060,432, filed on Oct. 6, 2014.

(51) Int. Cl. H04N 19/172; H04N 19/136; H04N 19/119

(52) U.S. Cl. CPC H04N 19/172; H04N 19/119; H04N 19/136

(57) ABSTRACT

Coding of screen content includes identifying corresponding areas in one or more previously coded frames to code unchanged areas in current frames. An unchanged area in a current frame is coded by copying a corresponding area from a previously coded frame or several previously coded frames. Usage of a copy mode to be applied to the unchanged areas is signaled in an encoding bitstream. The copy mode can be signaled for each unchanged area or a single copy mode is signaled for a group of unchanged areas. The copy mode can be automatically applied to one or more unchanged areas contiguous to the group of unchanged areas without further signaling the copy mode. Copying the corresponding area from the previously coded frame includes copying palette entries from the previously coded frame. Palette entries copied from the previously coded frame are reordered according to frequency of appearance.

### RELATED APPLICATIONS

This application claims the benefit of U.S. Provisional Application No. 61/952,158 filed Mar. 13, 2014. This application also claims the benefit of U.S. Provisional Application No. 62/060,432 filed Oct. 6, 2014.

### TECHNICAL FIELD

The present disclosure is generally directed to screen content coding in High Efficiency Video Coding.

### BACKGROUND

With the recent growth of cloud-based services and the substitution of conventional computers by mobile devices, such as smartphones and tablet computers, new scenarios emerge where computer generated content, or screen content (SC), is generated on one device but displayed using a second device. One possible scenario is that of an application running on a remote server with the display output being displayed on the local workstation of the user. Another scenario is the duplication of a smartphone or tablet computer screen to the screen of a television device, e.g., with the purpose of watching a movie on the big screen rather than on the small screen of the mobile device.

These scenarios are accompanied by the need of an efficient transmission of SC which should be capable of representing the SC video with sufficient visual quality while observing data rate constraints of existing transmission systems. A suitable solution for this challenge could be the usage of video coding technologies to compress the SC. These video coding technologies have been well studied during the last decades (See [1] D. Salomon and G. Motta, Handbook of Data Compression, 5th ed. London: Springer Verlag, 2010) and resulted in several often used video coding standards like:

MPEG-2 (See [2] ISO/IEC 13818-2, Generic coding of moving pictures and associated audio information—Part 2: Video/ITU-T Recommendation H.262, 1994; [3] B. G. Haskell, A. Puri, and A. N. Netravali, Digital Video: An Introduction to MPEG-2, New York: Chapman & Hall, 1997);

MPEG-4 (See [4] ISO/IEC 14496: MPEG-4 Coding of audio-visual objects; [5] F. Pereira and T. Ebrahimi, The MPEG-4 book, Upper Saddle River, N.J., USA: Prentice Hall PTR, 2002; [6] A. Puri and T. Chen, Multimedia Systems, Standards, and Networks, New York: Marcel Dekker, Inc., 2000); and

Advanced Video Coding (AVC) (See [7] ISO/IEC 14496-10, Coding of Audiovisual Objects-Part 10: Advanced Video Coding/ITU-T Recommendation H.264 Advanced video coding for generic audiovisual services, 2003).

Recently, the Joint Collaborative Team on Video Coding (JCT-VC) of the Moving Pictures Expert Group (MPEG) and of the Video Coding Experts Group (VCEG) developed the successor of AVC, which is called High Efficiency Video Coding (HEVC) (See [8] ITU-T Recommendation H.265/ISO/IEC 23008-2:2013 MPEG-H Part 2: High Efficiency Video Coding (HEVC), 2013) HEVC is based upon the same concept of hybrid video coding as AVC but achieves a compression performance twice as good as the predecessor standard by improving the existing coding tools and adding new coding tools (see [9] P. Hanhart, M. Rerabek, F. De Simone, and T. Ebrahimi, “Subjective quality evaluation of the upcoming HEVC video compression standard,” in SPIE Optical Engineering+Applications, 2012, p. 84990V)

However, HEVC has been developed with the aim of compressing natural, i.e., camera captured, content (NC). The consequence is that HEVC provides superior compression performance for NC but possibly is not the best solution to compress SC. Thus, after finalizing Version 1 of HEVC, a Call for Proposals for Screen Content Coding (SCC) was issued by the JCT-VC in January 2014. Responses to this call provided more sophisticated compression methods specifically designed for SC (See [10] Chen, Y. Chen, T. Hsieh, R. Joshi, M. Karczewicz, W.-S. Kim, X. Li, C. Pang, W. Pu, K. Rapaka, J. Sole, L. Zhang, and F. Zou, JCT-VC Q0031: Description of screen content coding technology proposal by Qualcomm, 17th Meeting of the Joint Collaborative Team on Video Coding (JCT-VC) of ITU-T SG16 WP3 and ISO/IEC JTC1/SC29/WG11, Valencia, ES, 27 Mar.-4 Apr. 2014; [11] C.-C. Chen, T.-S. Chang, R.-L. Liao, C.-W. Kuo, W.-H. Peng, H.-M. Hang, Y.-J. Chang, C.-H. Hung, C.-C. Lin, J.-S. Tu, K. Erh-Chung, J.-Y. Kao, C.-L. Lin, and F.-D. Jou, JCT-VC Q0032: Description of screen content coding technology proposal by NCTU and ITRI International, 17th Meeting of the Joint Collaborative Team on Video Coding (JCT-VC) of ITU-T SG16 WP3 and ISO/IEC JTC1/SC29/WG11, Valencia, ES, 27 Mar.-4 Apr. 2014; [12] P. Lai, T.-D. Chuang, Y.-C. Sun, X. Xu, J. Ye, S.-T. Hsiang, Y.-W. Chen, K. Zhang, X. Zhang, S. Liu, Y.-W. Huang, and S. Lei, JCT-VC Q0033: Description of screen content coding technology proposal by MediaTek, 17th Meeting of the Joint Collaborative Team on Video Coding (JCT-VC) of ITU-T SG16 WP3 and ISO/IEC JTC1/SC29/WG11, Valencia, ES, 27 Mar.-4 Apr. 2014; [13] Z. Ma, W. Wang, M. Xu, X. Wang, and H. Yu, JCT-VC Q0034: Description of screen content coding technology proposal by Huawei, 17th Meeting of the Joint Collaborative Team on Video Coding (JCT-VC) of ITU-T SGI 6 WP3 and ISO/IEC JTC1/SC29/WG11, Valencia, ES, 27 Mar.-4 Apr. 2014; and [14] B. Li, J. Xu, F. Wu, X. Guo, and G. J. Sullivan, JCT-VC Q0035: Description of screen content coding technology proposal by Microsoft, 17th Meeting of the Joint Collaborative Team on Video Coding (JCT-VC) of ITU-T SG16 WP3 and ISO/IEC JTC1/SC29/WG11, Valencia, ES, 27 Mar.-4 Apr. 2014).

FIGS. 1A and 1B show examples of a screen display with both screen content and natural content. It is worth noting that NC and SC videos may have characteristics that differ significantly in terms of edge sharpness and amount of different colors, among other properties, as has been previously studied (See [15] T. Lin, P. Zhang, S. Wang, K. Zhou, and X. Chen, “Mixed Chroma Sampling-Rate High Efficiency Video Coding for Full-Chroma Screen Content,” IEEE Trans. Circuits Syst. Video Technol., vol. 23, no. 1, pp. 173-185, January 2013). Therefore some SCC methods may not perform well for NC and some conventional HEVC coding tools may not perform well for SC. For instance, a standard HEVC coder would be sufficient for natural content but would either represent the SC only very poorly with strong coding artifacts, such as blurred text and blurred edges, or would result in very high bit rates for the SC if this content were to be represented with good quality. On the other hand, if SCC coding methods would be used to code the whole frame, they would perform well for the SC but would not be appropriate to describe the signal of the natural content. It may beneficial to use such SCC tools only for SC signals and vice-versa.

Another typical characteristic of SC videos may be the absence of changes between consecutive frames or parts of these frames in such videos. One possible scenario among a variety of other scenarios where such unchanged areas may appear is static background in SC.

SCC methods have been explored as part of the HEVC Range Extension development (See [16] D. Flynn, M. Naccari, C. Rosewarne, J. Sole, G. J. Sullivan, and T. Suzuki, High Efficiency Video Coding (HEVC) Range Extensions text specification: Draft 6, 16th Meeting of the Joint Collaborative Team on Video Coding (JCT-VC) of ITU-T SG 16 WP 3 and ISO/IEC JTC 1/SC 29/WG 11, San Jose 2014).

These SCC methods include palette coding (See [17] L. Guo, X. Guo, and A. Saxena, JCT-VC 01124: HEVC Range Extensions Core Experiment 4 (RCE 4): Palette Coding For Screen Content, 15th Meeting of the Collaborative Team on Video Coding (JCT-VC) of ITU-T SG 16 WP 3 and ISO/IEC JTC 1/SC 29/WG 11, Geneva, CH 2013; [18] W. Pu, X. Guo, P. Onno, P. Lai, and J. Xu, JCT-VC P0303: Suggested Software for the AHG on Investigation of Palette Mode Coding Tools, 16th Meeting of the Joint Collaborative Team on Video Coding (JCT-VC) of ITU-T SG 16 WP 3 and ISO/IEC JTC 1/SC 29/WG 11, San José, US, 9-17 Jan. 2014).

These palette coding methods are based upon the observation that typical SC, as it is shown in FIGS. 1A and 1B, consists of areas with a rather small amount of different sample values but with high frequencies, i.e., sharp edges. For instance, these could be areas with webpages where uniform background is combined with sharp text or the windows of computer programs. For blocks containing these characteristics, the palette coding methods suggest to create and signal a palette consisting of an entry for each color. Each entry in turn consists of an index and three sample values, one for each color space component. The palette is signaled as part of the bitstream for each coding unit (CU) for which the palette method is used. In order to encode the pixels of a block, the encoder determines for each pixel the corresponding palette entry and assigns the index of the entry to the pixel. The assigned indices are signaled as part of the bitstream. However, these palette coding methods and other screen content coding methods introduce inefficiencies in the transport of the image data.

### SUMMARY

From the foregoing, it may be appreciated by those skilled in the art that a need has arisen for improvements in coding of screen content. In accordance with the present disclosure, a system and method for screen content coding are provided that greatly reduce and substantially eliminate the problems associated with conventional screen content coding techniques.

This disclosure describes methods which may be used to code screen content. It is noted that all described methods may be applicable not only for static screen content but for any video signals with motion. References to coding of static screen content are only used as one application example for the described methods. In an embodiment, a copy mode is signaled in the coding unit syntax when an area of a current frame is unchanged from a previous frame. The copy mode may be signaled for each unchanged area of the current frame or a single copy mode may be signaled for a group of unchanged areas of the current frame.

In another embodiment, improved palette coding methods are disclosed. To achieve the best compression efficiency, the palette entries are ordered by the frequency of appearance, i.e., the entries with the highest frequency of appearance in a coding unit (CU) are assigned with the smallest indices, which is beneficial for coding the indices for each appearance. To further improve the compression efficiency, the palette entries of the current CU may be predicted based upon the palette entries of the previous CU. For this purpose a binary vector whose number of elements is equal to the number of entries of the previous palette is signaled as part of the bitstream. For each copied entry of the previous palette, the vector contains a 1 while the vector entry equals 0 if the entry of the previous palette is not copied.

The present disclosure describes many technical advantages over conventional screen content coding techniques. For example, one technical advantage is to implement a copy mode to indicate what portions of a current frame to use coding from a previously generated frame. Another technical advantage is to signal the copy mode in the coding unit or prediction unit syntax, either individually or as a group. Yet another technical advantage is to implement a palette mode where copied entries from one or more previous palettes and newly signaled entries are combined into a current palette and reordered according to a parameter such as frequency of appearance. Still another technical advantage is to provide an ability to explicitly signal palette reordering or implement implicit palette reordering as desired. Other technical advantages may be readily apparent to and discernable by those skilled in the art from the following figures, description, and claims.

### BRIEF DESCRIPTION OF THE DRAWINGS

For a more complete understanding of the present disclosure and the advantages thereof, reference is now made to the following description taken in conjunction with the accompanying drawings, wherein like reference numerals represent like parts, in which:

FIGS. 1A and 1B illustrate examples of a screen display with both screen content and natural content;

FIG. 2 illustrates an example of two ten entry palettes with a frequency of appearance for each entry;

FIG. 3 illustrates an example of a combined palette using a previous coding technique;

FIG. 4 illustrates an example of a combined palette using an improved coding technique;

FIG. 5 illustrates an example for creating a combined palette;

FIG. 6 illustrates an example of a combined palette where copied entries are not optimally sorted;

FIG. 7 illustrates an example of a combined palette with optimally sorted copied entries.

### DETAILED DESCRIPTION

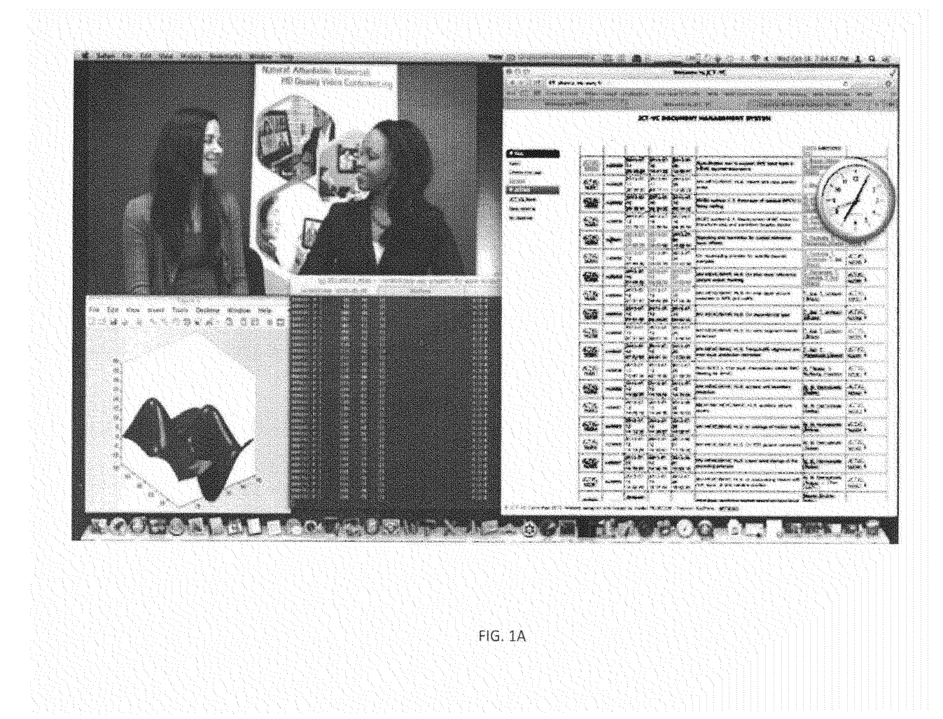

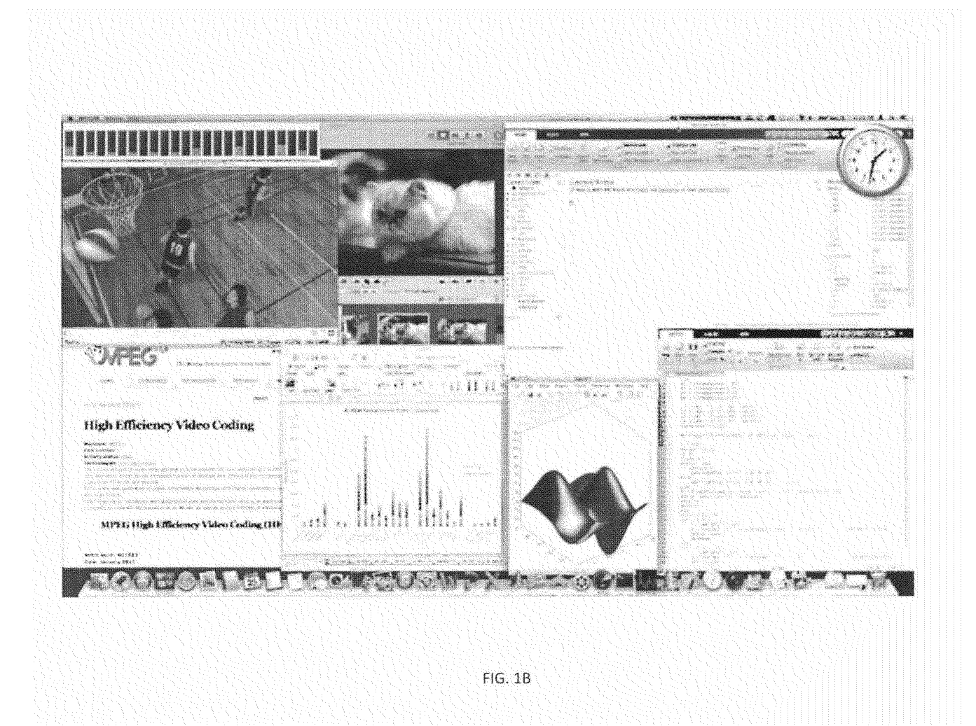

FIGS. 1A through 7, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system. Features shown and discussed in one figure may be implemented as appropriate in one or more other figures.

This disclosure addresses a scenario where some areas in the current frame may be unchanged compared to the corresponding areas in previously coded frames. It may be beneficial to use the corresponding areas in these previously coded frames to code the areas in the current frame. Therefore, the unchanged area in the current frame may be coded by copying the corresponding area from a previously coded frame or several previously coded frames. The corresponding area may be the area in the previously coded frame which is at the same position as the area in the current. As a result, full frame data need not be transmitted for each frame.

As one example embodiment, the sample values for an area in the current frame may be copied from the sample values at the corresponding location in a previously coded frame which is available as a reference picture. As another example embodiment, some additional processing, e.g., a filtering process, may be applied to the copied sample values.

The decision as to which reference picture is used as an origin for the sample value copy may be based on some information which is signaled as part of the bitstream or based on some predefined criteria. For instance, the reference picture with the smallest picture order count (POC) difference to the current picture, i.e., the closest reference picture, may be selected as the origin for the sample value copy. As another example embodiment, the selected reference picture may be signaled as part of the slice header or as part of a different parameter set.

The usage of the copy mode may be signaled as part of the bitstream. In one embodiment, the usage of the copy mode may be indicated with a binary flag. For instance, such a binary flag may be signaled as part of the coding unit (CU) or prediction unit (PU) syntax. Table 1 shows an example for the signaling of the copy mode usage as part of the CU syntax. The changes relative to the latest HEVC SCC text specification (See [19] R. Joshi and J. Xu, JCT-VC R1005: High Efficiency Video Coding (HEVC) Screen Content Coding: Draft 1, 18th Meeting of the Joint Collaborative Team on Video Coding (JCT-VC), Sapporo, JP, 30 Jun.-9 Jul. 2014) are highlighted in bold.

TABLE 1
Coding unit syntax

| | Descriptor |
|---|---|
| coding_unit( x0, y0, log2CbSize ) { | |
| if( transquant_bypass_enabled_flag ) | |
| cu_transquant_bypass_flag | ae(v) |
| 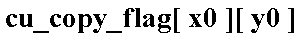 | 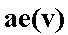 |
| 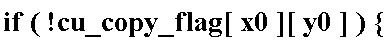 | |
| if( slice_type != I ) | |
| cu_skip_lag[ x0 ][ y0 ] | ae(v) |
| . . . | |
| 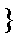 | |
| } | |

In this example embodiment, the binary flag cu_copy_flag is signaled prior to the syntax element cu_skip_flag. If cu_copy_flag is equal to 1, the copy mode is used to code the CU. Furthermore, if cu_copy_flag is equal to 1, all remaining CU and PU syntax elements are omitted. Otherwise, if cu_copy_flag is equal to 0, the regular CU and PU syntax is signaled.

Table 2 shows another example embodiment for the CU syntax where cu_copy_flag is signaled as first syntax element of the CU syntax. Additionally, a context model may be applied to code the cu_copy_flag. Different context models may be used depending on the values of previously coded cu_copy_flag values. Furthermore, the cu_copy_flag value may be predicted based on the value of previously coded cu_copy_flag values.

TABLE 2
Coding unit syntax

| | Descriptor |
|---|---|
| coding_unit( x0, y0, log2CbSize ) { | |
| 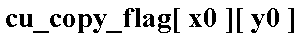 | 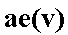 |
| 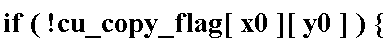 | |
| if( transquant_bypass_enabled_flag ) | |
| cu_transquant_bypass_flag | ae(v) |
| if( slice_type != I ) | |
| cu_skip_flag[ x0 ][ y0 ] | ae(v) |
| . . . | |
| 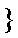 | |
| } | |

The signaling overhead for the copy mode usage may be further reduced. For instance, there may be scenarios in which it is not beneficial to signal a flag for every CU. Thus, as another example embodiment, the copy mode usage may be signaled only for certain CUs or certain types of CUs. For instance, the copy mode usage syntax element may only be signaled for CUs of a certain depths, e.g., for CUs of depth zero referred to as coding tree units (CTU).

Furthermore, the signaling overhead may be additionally reduced by utilizing redundancy with respect to the copy mode usage between several parts of the coded signal, e.g., between several CUs of a coded frame. As one example embodiment, it may be beneficial to apply more sophisticated signaling means for a scenario where several CUs are coded using the copy mode in order to have less signaling overhead compared to signaling the copy mode usage for every CU. For instance, the copy mode usage may be signaled only once for several CUs which are coded using the copy mode. Another syntax element may be signaled to indicate that a group of CUs is coded with the copy mode. For instance, this syntax element may be referred to as “cu_copy_group”. Additionally, a context model may be applied to code the cu_copy_group. Different context models may be used depending on the values of previously coded cu_copy_group values. Furthermore, the cu_copy_group value may be predicted based on the value of previously coded cu_copy_group values. Different signaling means may be applied for the cu_copy_group syntax element and some examples are described below.

As one example embodiment, the usage of the copy mode may be signaled for rows in a frame, e.g., for CTU rows. For instance, run length coding may be applied to signal the number of consecutive CTUs which are coded using the copy mode. For example, the syntax element cu_copy_group may be defined in such a way that cu_copy_group may indicate a run length value corresponding to the number of consecutive CTUs which are coded using the copy mode. Similar signaling means may be applied at the CU or PU level. Table 3 shows an example for the CTU row run length signaling of the copy mode usage.

TABLE 3
Coding unit syntax for CTU row run length copy mode usage coding

| | Descriptor |
|---|---|
| coding_unit( x0, y0, log2CbSize ) { | |
| 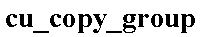 | 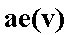 |
| 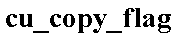 | 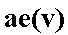 |
| 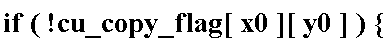 | |
| if( transquant_bypass_enabled_flag ) | |
| cu_transquant_bypass_flag | ae(v) |
| if( slice_type != I ) | |
| cu_skip_flag[ x0 ][ y0 ] | ae(v) |
| 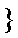 | |
| } | |

In this example, cu_copy_group may indicate a run length for the number of CTUs for which the copy mode usage may be signaled. Furthermore, cu_copy_flag may indicate whether the given number of CTUs is coded using the copy mode or not. In case cu_copy_group and cu_copy_flag are signaled for a current CTU, these syntax elements may not be present in the bitstream for the consecutive CTUs covered by the run length signaled by cu_copy_group. Furthermore, the cu_copy_flag values for these consecutive CTUs may be inferred as the cu_copy_flag value of the current CTU. As another example embodiment, the run length may be continued to the next CTU row in order to signal rectangular regions. For this purpose, the cu_copy_group value may be bigger than the number of remaining CTUs in the current CTU row. For instance, the run length may be continued with the first CTU in the next CTU row if the end of the current CTU row is reached. As another example, the run length may be continued with the CTU in the next CTU row which is located below the CTU for which the cu_copy_group syntax element is signaled.

As another example embodiment, the usage of the copy mode may be signaled for regions in the frame. For instance, the frame may be partitioned into regions. Furthermore, it may be signaled with a cu_copy_group syntax element, e.g., a binary flag, for these regions that the copy mode is applied to code these regions. Furthermore, in case it is signaled that the copy mode is used to code a region, no further signaling is required for CUs or PUs within this region. For instance, these regions may be slices, tiles of a frame, or a complete frame. As another example, regions of a certain size may be defined and used to apply the region based copy mode. Table 4 shows an example for the signaling of the cu_copy_group syntax element as part of the slice header. Table 5 shows an example for the signaling of the cu_copy_group syntax element as part of the picture parameter set.

TABLE 4
Slice header syntax

| | De- |
|---|---|
| | scrip- |
| | tor |
| slice_segment_header( ) { | |
| . . . | |
| If (slice_segment_header_extension_present_flag) { | |
| slice_segment_header_extension_length | ue(v) |
| for( i = 0; i < slice_segment_header_extension_length; i++) | |
| slice_segment_header_extension_data_byte[I] | u(8) |
| } | |
| 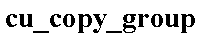 | 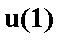 |
| byte_alignment( ) | |
| } | |

TABLE 5
Picture parameter set syntax

| | Descriptor |
|---|---|
| pic_parameter_set_rbsp( ) { | |
| pps_pic_parameter_set_id | ue(v) |
| pps_seq_parameter_set_id | ue(v) |
| dependent_slice_segments_enabled_flag | u(1) |
| output_flag_present_flag | u(1) |
| num_extra_slice_header_bits | u(3) |
| sign_data_hiding_enabled_flag | u(1) |
| cabac_init_present_flag | u(1) |
| num_ref_idx_10_default_active_minus1 | ue(v) |
| num_ref_idx_11_default_active_minus1 | ue(v) |
| init_qp_minus26 | se(v) |
| constrained_intra_pred_flag | u(1) |
| transform_skip_enabled_flag | u(1) |
| cu_qp_delta_enabled_flag | u(1) |
| if( cu_qp_delta_enabled_flag ) | |
| diff_cu_qp_delta_depth | ue(v) |
| pps_cb_qp_offset | se(v) |
| pps_cr_qp_offset | se(v) |
| pps_slice_chroma_qp_offsets_present_flag | u(1) |
| weighted_pred_flag | u(1) |
| weighted_bipred_flag | u(1) |
| transquant_bypass_enabled_flag | u(1) |
| tiles_enabled_flag | u(1) |
| entropy_coding_sync_enabled_flag | u(1) |
| 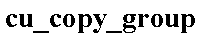 | 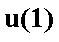 |
| . . . | |
| } | |

As another example embodiment, prediction of the usage of the copy mode may be based on previously coded frames and indicated by a flag. For instance, the usage of the copy mode for a previous frame may be used for the current frame. A frame level flag may be signaled to indicate that the copy mode usage of a previous frame is used as a prediction for the copy mode usage in the current frame. For instance, this frame level flag may be signaled as part of the slice header or the picture parameter set. If the copy mode usage of a previous frame is used as a prediction for the copy mode usage of the current frame, a prediction error for the copy mode usage may be signaled. For instance, the difference between the copy mode usage in a previous frame and the copy mode usage in the current frame may be signaled.

There may be a scenario in which a number of frames may be unchanged. For instance, consecutive frames in a screen content sequence may be unchanged. The coding of such frames may be enhanced by coding methods specifically addressing the coding of unchanged frames. However, HEVC lacks such specific coding methods.

If consecutive frames are unchanged, it may be beneficial to signal this characteristic as part of the bitstream. Furthermore, it may be beneficial to employ this signaled information in order to improve the compression efficiency for the unchanged frames.

As one example embodiment, a syntax element may be signaled to indicate that subsequent frames may be unchanged with respect to the current frame. For instance, the syntax element may be signaled as part of the picture parameter set or as part of the slice header. Moreover, if the syntax element indicates that subsequent frames will be unchanged, these subsequent frames may be coded without signaling additional syntax for these frames by copying the current frame.

In order to determine the number of consecutive frames which are coded by copying the current frame, different methods may be applied whereof some examples are described in the following. As one example embodiment, all subsequent frames may be copied from the current frame until the end of this procedure is signaled. As another example embodiment, a second syntax element may be signaled to indicate the number of consecutive frames which may be copied from the current frame.

The presence of the syntax elements described above in a bitstream may be controlled by a syntax element static_screen_content_coding_enabled_flag. If static_screen_content_coding_enabled_flag is equal to 1, the syntax elements may be present in a bitstream as described. If static_screen_content_coding_enabled_flag is equal to 0, none of the described syntax elements may be present in a bitstream. Furthermore, the static_screen_content_coding_enabled_flag syntax element may be signaled on a higher level than the syntax elements whose presence is controlled by static_screen_content_coding_enabled_flag. For instance, the static_screen_content_coding_enabled_flag syntax element may be signaled on a sequence level, e.g., as part of the sequence parameter set. Table 6 shows an example for the signaling as part of the sequence parameter set. Table 7 shows an example for the modified coding unit syntax signaling wherein the cu_copy_flag is only signaled as part of the bitstream if static_screen_content_coding_enabled_flag is equal to 1.

TABLE 6
Sequence parameter set syntax

| | Descriptor |
|---|---|
| seq_parameter_set_rbsp( ) { | |
| . . . | |
| 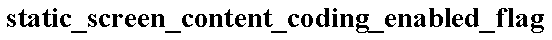 | 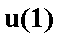 |
| . . . | |
| } | |

TABLE 7
Coding unit syntax

| | Descriptor |
|---|---|
| coding_unit( x0, y0, log2CbSize ) { | |
| If ( static_screen_content_coding_enabled_flag ) | |
| 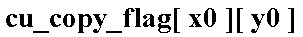 | 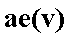 |
| if ( !cu_copy_flag[ x0 ][ y0 ] ) { | |
| . . . | |
| } | |
| } | |

Copying and syntax signaling may also be applied when performing palette coding. Palette entries may be ordered in such a way that the palette index of the entry is smaller the more often this entry is used to describe a pixel in a CU. Another improvement is the prediction of the current palette from the previous palette in such a way that entries which appear in both palettes are copied from the previous palette instead of signaling the entries as part of the new palette.

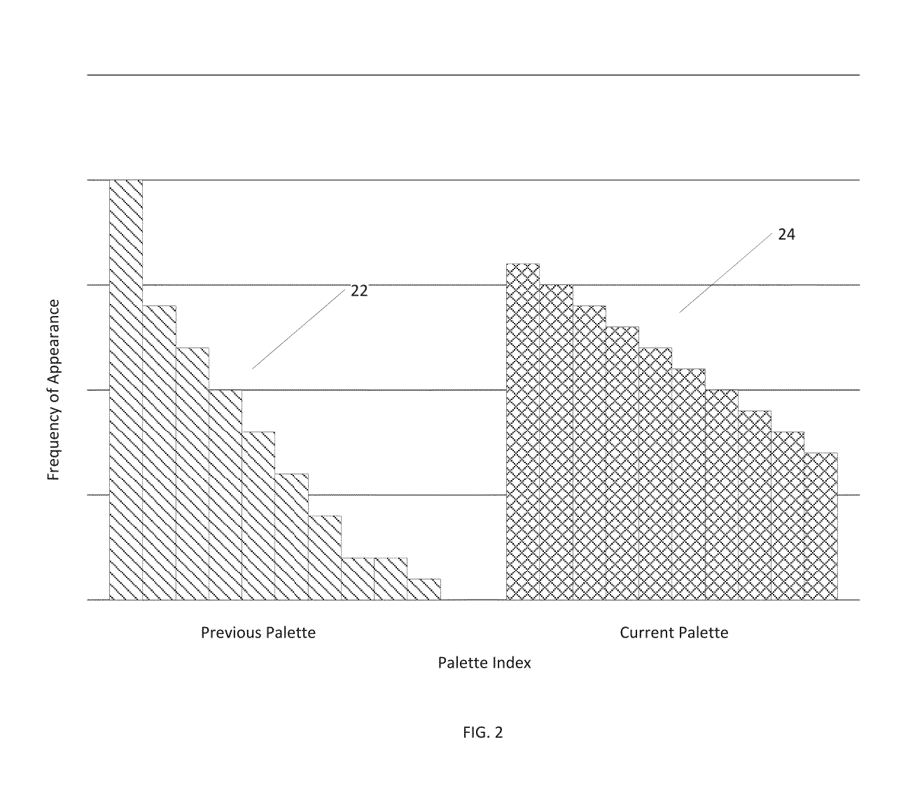

FIG. 2 shows an example of two palettes, a previous palette 22 and a current palette 24, where it is assumed that both palettes 22 and 24 have ten entries. It is further assumed that some entries appear in both palettes 22 and 24, thus they may be copied from the previous palette 22 to form a combined palette. For this illustration, it is assumed that five elements appear in both palettes 22 and 24.

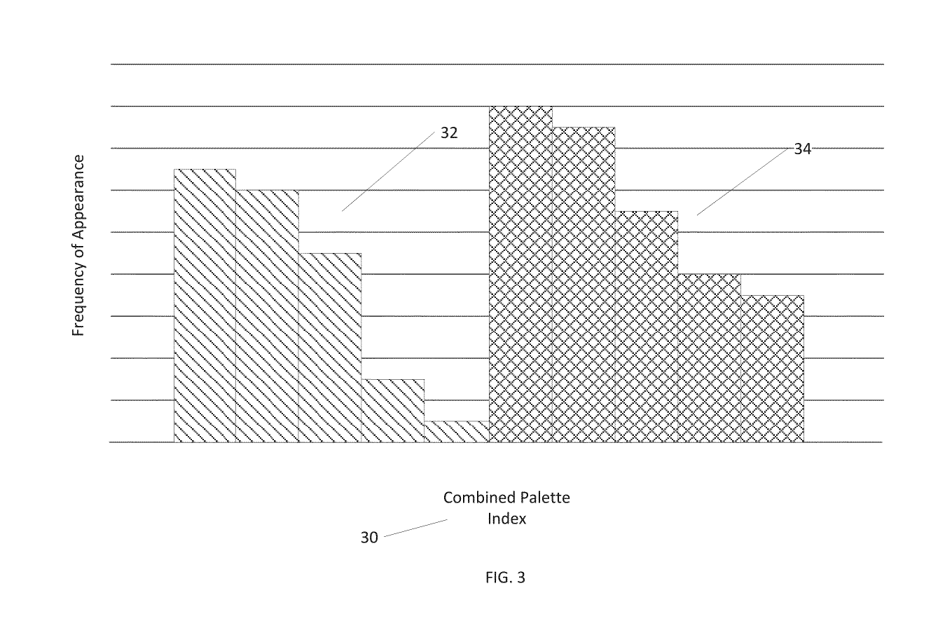

FIG. 3 shows a combined palette 30 resulting from combining the two palettes 22 and 24 in accordance with the latest working draft version of the original palette coding method (See [18] above). As shown, entries 32 originating from the previous palette 22 are placed at the beginning of the combined palette 30 followed by entries 34 taken from the current palette 24. Due to this approach, the entries 32 and 34 in the combined palette 30 are no longer ordered by their frequency of appearance. Thus, no efficient coding of the palette indices of the entries 32 and 34 is possible because the most often used entries do not have the smallest indices.

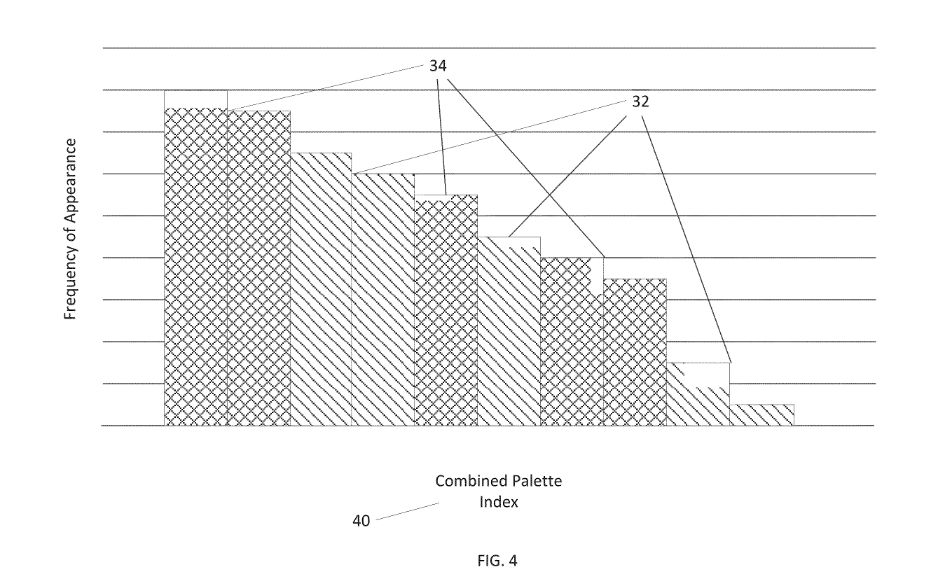

To improve the efficiency for such a scenario, a reordering method which reorders the entries of the combined palette 30 in such a way that the most often used entries are assigned with the smallest indices is provided. FIG. 4 shows an example of a combined palette 40 after applying the proposed reordering for the above-mentioned example.

The reordering may be signaled as part of the bitstream. In one embodiment, the reordering is signaled as part of the bitstream by signaling a binary vector whose number of elements is equal to the number of entries in the combined palette 40. The number of entries in the combined palette 40 is derived as the summation of copied entries 32 and newly signaled entries 34. The elements of the vector are equal to a first value if an entry 34 from the current palette 24 is placed at the corresponding position of the combined palette 40. The elements of the vector are equal to a second value if an entry 32 from the previous palette 22 is placed at the corresponding position of the combined palette 40.

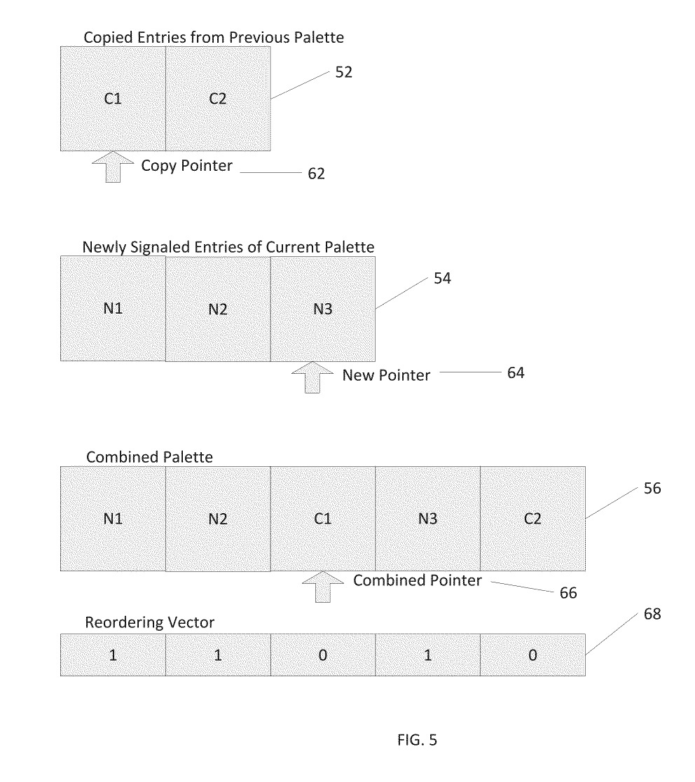

FIG. 5 shows an example of how the copied palette entries 32 and the newly signaled entries 34 may be combined. An encoder and a decoder may implement three lists, a list 52 for the copied entries 32, a list 54 for the newly signaled entries 34, and a list 56 for the entries of the combined palette 40. There may further be three pointers, each belonging to one corresponding list, which are named accordingly as copy pointer 62, new pointer 64, and combined pointer 66, respectively. The copy pointer 62 and the new pointer 64 may indicate which entry of the list 52 with copied entries 32 and of the list 54 with newly signaled entries 34, respectively, shall be extracted next. The combined pointer 66 may indicate which entry in the list for the entries of the combined palette 40 shall be filled next. At the start of the reordering process, all pointers are initialized to the first entry of their corresponding list. A reordering vector 68 indicates what entry is located at each position of combined palette 40. If the entry in the reordering vector 68 at the position indicated by the combined pointer 66 is equal to a first value, the entry from the list 54 with newly signaled entries 34 indicated by the new pointer 64 shall be copied to the entry in the combined list 56 whose position is indicated by the combined pointer 66. Subsequently, the new pointer 64 and the combined pointer 66 shall be incremented by one position. If the entry in the reordering vector 68 at the position indicated by the combined pointer 66 is equal to a second value, the entry from the list 52 with copied entries 32 indicated by the copy pointer 62 shall be copied to the entry in the combined list 56 whose position is indicated by the combined pointer 66. Subsequently, the copy pointer 62 and the combined pointer 66 shall be incremented by one position.

There may be other palette reordering constraints, which indicate how a palette shall be reordered. Such ordering constraints may be, among others, the frequency of appearance in the current frame up to the current block or some previous block, the frequency of appearance in the current and/or previous pictures, the frequency of appearance for signaled entries after the index prediction process (e.g., after run-length and/or copy from above prediction).

Other methods may be used to achieve the reordering. For instance, there may be a scenario where it is desired to predict the current palette based on several previously coded palettes. In this case, it may be beneficial to reorder the entries of all palettes optimally.

Taking into account that the number of copied entries, the number of newly signaled entries, and thus the size of the combined palette are known to the decoder, the reordering vector needs only to be signaled until the positions of either all copied entries or all positions of newly signaled entries are described. The values for the rest of the reordering vector may be inferred since they may only indicate that entries are copied from the one not-yet empty list.

The reordering method may be further improved by enabling or disabling the method for a sequence, for a picture, or a region of a picture (e.g., a CU or a different kind of region) rather than applying the method for the whole sequence or picture. Among other possibilities, this form of signaling may be applied in the sequence parameter set (SPS), in the picture parameter set (PPS), as supplement enhancement information (SEI) message, in the reference picture set (RPS), in the slice header, on largest CU (LCU) or CU level.

Additionally, the palette reordering method may be further improved by initializing the palette entries. This could be achieved implicitly or explicitly. For instance, the palette entries may be initialized based on statistical information from the current and/or previous pictures. In one embodiment, the first entries of the combined palette may be initialized with the most frequently appearing entries of previous palettes. The number of initialized entries and the position of the initialized entries may be fixed or may vary. These two properties may be derived implicitly at the decoder or signaled explicitly as part of the bitstream.

For a video coding expert it is easy to see that another method of signaling, e.g., run-length coding, may be used to achieve the same reordering.

Different methods may be applied to reorder the palette. For instance, the copied entries from the previous palette may be interleaved with newly signaled entries. For example, the combined palette may be constructed by alternating copied entries and newly signaled entries.

Table 8 shows a possible text specification for the proposed palette reordering method. The text is integrated in the latest working draft version of the original palette coding method (See [18] above). The text specification shows the changes between the latest working draft version of the original palette coding method (See [18] above) and the latest HEVC Range Extensions Draft (See [16] above). Additional changes between the proposed reordering method and the latest working draft version of the original palette coding method (See [18] above) are shown in bold. Though a specific example is shown, different text specifications may be used to achieve palette reordering.

TABLE 8
Text Specification for reordering the palette

| | Descriptor |
|---|---|
| palette_coding_component( x0, y0, CbWidth, CbHeight, NumComp ) { | |
| compOffset = ( NumComp = = 3 ) ? 0 : ( NumComp − 1 ) | |
| nCbS = ( 1 << log2CbSize ) | |
| numPredPreviousPalette = 0 | |
| for( i = 0; i < previousPaletteSize; i++ ) { | |
| previous_palette_entry_flag[ i ] | ae(v) |
| if ( previous_palette_entry_flag[ i ] ) { | |
| for ( cIdx = compOffset; cIdx < NumComp + compOffset; | |
| cIdx++ ) | |
| palette_entries[ cIdx ][ numPredPreviousPalette ] = | |
| previousPaletteEntries[ cIdx ][ i ] | |
| numPredPreviousPalette++ | |
| } | |
| } | |
| if( numPredPreviousPalette < 31 ) | |
| palette_num_signalled_entries | ae(v) |
| for ( cIdx = compOffset; cIdx < NumComp + compOffset; cIdx++ ) | |
| for( i = 0; i < palette_num_signalled_entries; i++ ) | |
| palette_entries[ cIdx ][ numPredPreviousPalette + i ] | ae(v) |
| palette_size = numPredPreviousPalette + palette_entries | |
| 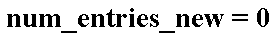 | |
| 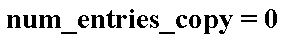 | |
| 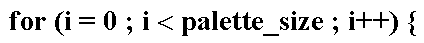 | |
| 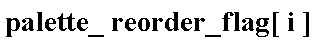 | 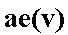 |
| 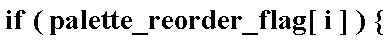 | |
| 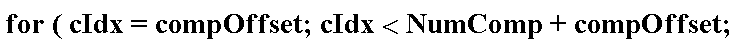 | |
| 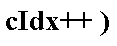 | |
| 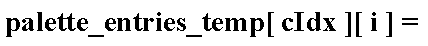 | |
| 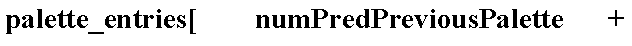 | |
| 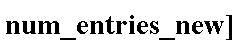 | |
| 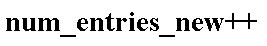 | |
| 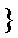 | |
| 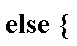 | |
| 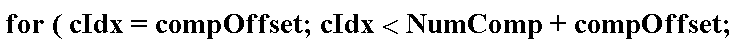 | |
| 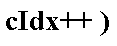 | |
| 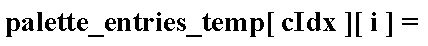 | |
| 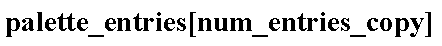 | |
| 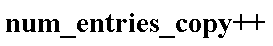 | |
| 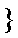 | |
| 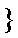 | |
| 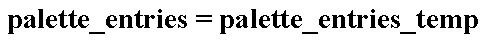 | |
| previousPaletteSize = palette_size | |
| previousPaletteEntries = palette_entries | |
| scanPos = 0 | |
| while( scanPos < nCbS * nCbS ) { | |
| if ( yC != 0 && previous_run_type_flag != | |
| COPY_ABOVE_RUN_MODE ) | |
| palette_run_type_flag[ xC ][ yC ] | ae(v) |
| else | |
| palette_run_type_flag[ xC ][ yC ] = INDEX_RUN_MODE | |
| if( palette_run_type_flag[ xC ][ yC ] = = INDEX_RUN_MODE ) | |
| { | |
| palette_index | ae(v) |
| if( palette_index = = palette_size ) { /* ESCAPE_MODE */ | |
| xC = scanPos % nCbS | |
| yC = scanPos / nCbS | |
| scanPos++ | |
| for( cIdx = compOffset; cIdx < NumComp + compOffset; | |
| cIdx++ ) { | |
| palette_escape_val | ae(v) |
| samples_array[ cIdx ][ xC ][ yC ] = palette_escape_val | |
| } | |
| } else { | |
| palette_run | ae(v) |
| previous_run_type_flag = palette_run_type_flag | |
| runPos = 0 | |
| while ( runPos <= palette_run ) { | |
| xC = scanPos % nCbS | |
| yC = scanPos / nCbS | |
| paletteMap[ xC ][ yC ] = palette_index | |
| runPos++ | |
| scanPos++ | |
| } | |
| } else { /* COPY_ABOVE_RUN_MODE */ | |
| paletteMap[ xC ][ yC ] = paletteMap[ xC ][ yC − 1 ] | |
| for( cIdx = compOffset; cIdx < NumComp + compOffset; | |
| cIdx++ ) | |
| samples_array[ cIdx ][ xC ][ yC ] = | |
| palette_entries[ cIdx ][ paletteMap[ xC ][ yC ]] | |
| runPos++ | |
| scanPos++ | |
| } | |
| } | |
| } | |
| } | |

When palette_reorder_flag[i] is equal to 1, it indicates that the i-th element of the combined palette is taken from the newly signaled palette entries. When palette_reorder_flag[i] is equal to 0, it indicates that the i-th element of the combined palette is copied from the previous palette.

There may be scenarios where a decoder has information that the order of the palette entries shall be changed. Among other possibilities this information may be signaled as part of the bitstream or be inferred implicitly by the decoding process. If the decoder is aware of such information, the decoder shall change the order of the palette entries accordingly.

For instance the decoder may receive a bitstream which contains syntax elements that indicate how the entries of the palette shall be reordered. If the decoder receives such a bitstream, the newly signaled palette entries and the palette entries which are copied from the previous palette, shall be reordered according to a specified process. If the syntax element palette_reorder_flag[i] specifies that the i-th entry of the combined palette shall be extracted from the list with newly signaled palette entries, the decoder shall move the corresponding entry in this list to the combined list. If the syntax element palette_reorder_flag[i] specifies that the i-th entry of the combined palette shall be extracted from the list with copied palette entries, the decoder shall move the corresponding entry in this list to the combined list. Other methods may be used to achieve the palette reordering.

From the foregoing, one embodiment for palette reordering uses signaling means to describe how the reordering should be executed. In other embodiments, it may not be desired to signal the palette reordering explicitly. For such embodiments, the idea of reordering the palette entries may still be beneficial by using implicit methods to modify the order of the palette entries.

One possible approach to reorder the palette implicitly is to gather statistical information regarding the usage of palette entries at the decoder while decoding palette coded CUs and to use this information to find the optimal order of the palette. Thus, taking into account that the statistical information is collected at the decoder, the bitstream does not need to contain information of how to reorder the palette. However, although no signaling is required for implicit palette reordering, additional information may be signaled nevertheless to further enhance the proposed method. For instance, it may be signaled whether the proposed method is enabled or disabled for a sequence, for a picture, or a region of a picture (e.g., a CU or a different kind of region) rather than applying the method for the whole sequence or picture. Among other possibilities, this form of signaling may be applied in the SPS, in the PPS, in the RPS, in the slice header, as SEI message, on LCU or CU level.

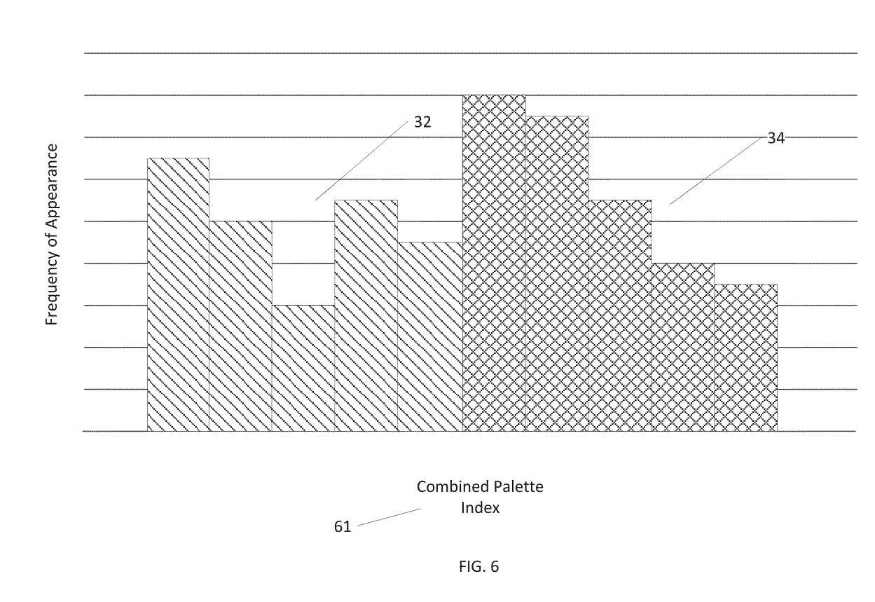

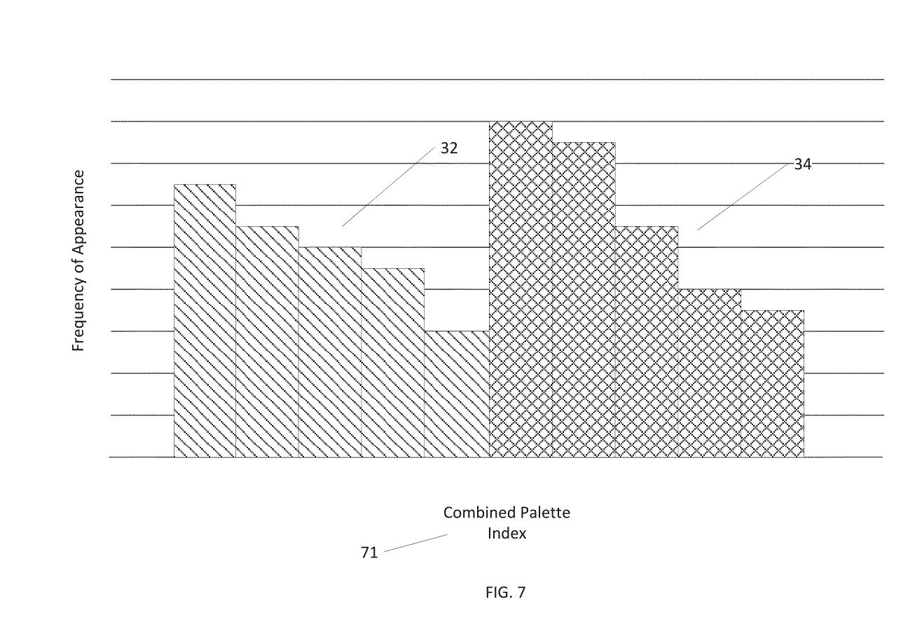

One embodiment for implicit palette reordering is to reorder the palette after encoding and decoding a CU that is coded in palette mode. Although this might not directly be beneficial for this specific CU, subsequent CUs may profit by the postponed reordering. An example may be considered where a CU is decoded using a palette whose entries are not ordered optimally since the order of entries does not reflect their respective frequency of appearance. If the following palette would by predicted by copying reused entries from that previously decoded palette to the first positions of the new combined palette, these first entries in the combined list may not be ordered optimally either. FIG. 6 illustrates an example of a combined palette 61 whose copied entries are not sorted optimally. To address this issue, the palette entries may be reordered after a CU has been encoded and decoded, respectively, such that the new order of entries reflects their corresponding frequency of appearance within that CU. This implicit reordering shall be applied prior to using this palette for the prediction of the following palette. FIG. 7 shows a combined palette 71 implicitly reordered with optimally sorted entries.

As in explicit palette reordering, other methods and ordering constraints for implicit palette reordering may be applied to achieve the reordering. Alternative ordering constraints may include, among others, the frequency of appearance in the current frame up to the current or some previous block, the frequency of appearance in the current and/or previous pictures, and the frequency of appearance for signaled entries after the index prediction process (e.g., after run-length and/or copy from above prediction).

As in explicit palette reordering, different methods may be applied to implicitly reorder the palette. For instance, the copied entries from the previous palette may be interleaved with newly signaled entries. For instance, the combined palette may be constructed by alternating copied entries and newly signaled entries.

In one embodiment, it has been discussed that no additional signaling is required for implicit palette reordering. However, in another embodiment, the method may be further enhanced by combining the implicit palette reordering method with additional signaling. For instance, the implicit palette reordering method may only be beneficial for some palettes while it is not beneficial for other palettes. Thus, it may be signaled whether implicit palette reordering shall be applied for a palette or not. Among other possibilities, this form of signaling may be implemented in the SPS, in the PPS, in the RPS, in the slice header, as SEI message, on LCU or CU level.

Table 9 shows a possible text specification for signaling implicit palette reordering. The text is integrated in the latest working draft version of the original palette coding method (See [18] above). The text specification shows the changes between the latest working draft version of the original palette coding method (See [18] above) and the latest HEVC Range Extensions Draft (See [16] above). Additional changes between the proposed reordering method and the latest working draft version of the original palette coding method (See [18] above) are shown in bold.

TABLE 9
Text Specification for Implicit Palette Reordering

| | Descriptor |
|---|---|
| palette_coding_component( x0, y0, CbWidth, CbHeight, NumComp ) { | |
| compOffset = ( NumComp = = 3 ) ? 0 : ( NumComp − 1 ) | |
| nCbS = ( 1 << log2CbSize ) | |
| numPredPreviousPalette = 0 | |
| for( i = 0; i < previousPaletteSize; i++ ) { | |
| previous_palette_entry_flag[ i ] | ae(v) |
| if ( previous_palette_entry_flag[ i ] ) { | |
| for ( cIdx = compOffset; cIdx < NumComp + compOffset; | |
| cIdx++ ) | |
| palette_entries[ cIdx ][ numPredPreviousPalette ] = | |
| previousPaletteEntries[ cIdx ][ i ] | |
| numPredPreviousPalette++ | |
| } | |
| } | |
| if( numPredPreviousPalette < 31 ) | |
| palette_num_signalled_entries | ae(v) |
| for ( cIdx = compOffset; cIdx < NumComp + compOffset; cIdx++ ) | |
| for( i = 0; i < palette_num_signalled_entries; i++ ) | |
| palette_entries[ cIdx ][ numPredPreviousPalette + i ] | ae(v) |
| palette_size = numPredPreviousPalette + palette_entries | |
| 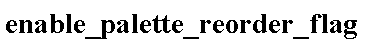 | 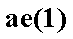 |
| previousPaletteSize = palette_size | |
| previousPaletteEntries = palette_entries | |
| scanPos = 0 | |
| while( scanPos < nCbS * nCbS ) { | |
| if ( yC != 0 && previous_run_type_flag != | |
| COPY_ABOVE_RUN_MODE ) | |
| palette_run_type_flag[ xC ][ yC ] | ae(v) |
| else | |
| palette_run_type_flag[ xC ][ yC ] = INDEX_RUN_MODE | |
| if( palette_run_type_flag[ xC ][ yC ] = = INDEX_RUN_MODE ) { | |
| palette_index | ae(v) |
| if( palette_index = = palette_size ) { /* ESCAPE_MODE */ | |
| xC = scanPos % nCbS | |
| yC = scanPos / nCbS | |
| scanPos++ | |
| for( cIdx = compOffset; cIdx < NumComp + compOffset; | |
| cIdx++ ) { | |
| palette_escape_val | ae(v) |
| samples_array[ cIdx ][ xC ][ yC ] = palette_escape_val | |
| } | |
| } else { | |
| palette_run | ae(v) |
| previous_run_type_flag = palette_run_type_flag | |
| runPos = 0 | |
| while ( runPos <= palette_run ) { | |
| xC = scanPos % nCbS | |
| yC = scanPos / nCbS | |
| paletteMap[ xC ][ yC ] = palette_index | |
| runPos++ | |
| scanPos++ | |
| } | |
| } else { /* COPY_ABOVE_RUN_MODE */ | |
| paletteMap[ xC ][ yC ] = paletteMap[ xC ][ yC − 1 ] | |
| for( cIdx = compOffset; cIdx < NumComp + compOffset; | |
| cIdx++ ) | |
| samples_array[ cIdx ][ xC ][ yC ] = | |
| palette_entries[ cIdx ][ paletteMap[ xC ][ yC ]] | |
| runPos++ | |
| scanPos++ | |
| } | |
| } | |
| } | |
| } | |

When enable_palette_reorder_flag is equal to 1, it indicates that the implicit palette reordering method shall be applied for this CU. When enable_palette_reorder_flag is equal to 0, it indicates that the implicit palette reordering method shall not be applied for this CU. Though an example is provided above, other text specifications may be applied to enable or disable the implicit palette reordering method.

In some embodiments, some or all of the functions or processes of the one or more of the devices and other hardware devices discussed above are implemented or supported by a computer program that is formed from computer readable program code and that is embodied in a computer readable medium and executed by a processor. The phrase “code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for screen content coding, comprising:
identifying, in one or more previously coded frames, an area corresponding to an unchanged area in a current frame to code the unchanged area in current frames, wherein the unchanged area in a current frame is coded by copying the identified corresponding area from a previously coded frame or several previously coded frames; and
signaling usage of a copy mode to be applied to the unchanged area in the current frame.

2. The method of claim 1, further comprising:
selecting a previously coded frame as a reference picture, wherein the corresponding area in the reference picture is located at a same position as the unchanged area in the current frame.

3. The method of claim 1, wherein the copy mode is signaled for each unchanged area in the current frame.

4. The method of claim 1, wherein one copy mode is signaled for a group of unchanged areas.

5. The method of claim 4, wherein the copy mode includes a run length value identifying a number of unchanged areas for which the copy mode is applied.

6. The method of claim 4, further comprising:
automatically applying the copy mode to one or more unchanged areas contiguous to the group of unchanged areas without further signaling the copy mode.

7. The method of claim 1, further comprising:
signaling the copy mode usage for the current frame based on usage of the copy mode for a previous frame.

8. The method of claim 1, wherein the unchanged areas encompass an entirety of the current frame, the signaling identifying a number of consecutive frames for usage of the copy mode.

9. A non-transitory computer readable medium including code for screen content coding, the code when executed operable to:
Identify, in one or more previously coded frames, an area corresponding to an unchanged area in a current frame to code the unchanged area in current frames, wherein the unchanged area in a current frame is coded by copying the identified corresponding area from a previously coded frame or several previously coded frames; and
signal usage of a copy mode to be applied to the unchanged areas in the current frame.

10. The non-transitory computer readable medium of claim 9, the code further operable to:
select a previously coded frame as a reference picture, wherein the corresponding area in the reference picture is located at a same position as the unchanged area in the current frame.

11. The non-transitory computer readable medium of claim 9, wherein the copy mode is signaled for each unchanged area in the current frame.

12. The non-transitory computer readable medium of claim 9, wherein one copy mode is signaled for a group of unchanged areas.

13. The non-transitory computer readable medium of claim 12, wherein the copy mode includes a run length value identifying a number of unchanged areas for which the copy mode is applied.

14. The non-transitory computer readable medium of claim 12, wherein the code is further operable to:
automatically apply the copy mode to one or more unchanged areas contiguous to the group of unchanged areas without further signaling the copy mode.

15. The non-transitory computer readable medium of claim 9, wherein the code is further operable to:
signal the copy mode usage for the current frame based on usage of the copy mode for a previous frame.

16. The non-transitory computer readable medium of claim 9, wherein the unchanged areas encompass an entirety of the current frame, the signaling identifying a number of consecutive frames for usage of the copy mode.

17. A method for screen content coding, comprising:
identifying copied palette entries from a previous palette found in a current palette;
identifying newly signaled palette entries in the current palette not found in the previous palette;
combining copied palette entries and newly signaled entries into a combined palette, wherein combining includes reordering the newly signaled palette entries and the copied palette entries according to a frequency of appearance;

[symbol]

18. The method of claim 17, wherein reordering the newly signaled palette entries and the copied palette entries according to a frequency of appearance includes:
placing the copied palette entries into a copied entry list according to frequency of appearance;
associating a copy pointer with the copied entry list, the copy pointer identifying a particular copied palette entry in the copied entry list;
placing the newly signaled palette entries into a newly signaled entry list according to frequency of appearance;
associating a new pointer with the newly signaled entry list, the new pointer identifying a particular newly signaled palette entry in the copied entry list;
comparing a frequency of appearance of the particular copied palette entry to a frequency of appearance of the particular newly signaled palette entry;
extracting one of the particular copied palette entry and the particular newly signaled palette entry having a higher frequency of appearance;
associating a combined pointer with a combined entry list, the combined pointer identifying a particular combined entry location in the combined entry list;
inserting the extracted entry into the particular combined entry location.

19. The method of claim 18, further comprising:
incrementing the combined pointer to identify a new combined entry location;
incrementing one of the copied pointer and the new pointer corresponding to the extracted entry;
repeating the comparing, extracting, and inserting steps for current values of the copied pointer, the new pointer, and the combined pointer.

20. The method of claim 18, further comprising:
generating a reorder vector, the reorder vector identifying entries in the combined palette as either a copied palette entry or a newly signaled palette entry.
